(19) United States
(12) Patent Application Publication
(10) Pub. No.: US 2016/0271530 A1
(43) Pub. Date: Sep. 22, 2016

(54) CARTRIDGE FILTER

(71) Applicant: DELSTAR TECHNOLOGIES, INC., Middletown, DE (US)

(72) Inventors: James Milton DICKSON, Yardley, PA (US); Robert Benton NEWCOME, Little Rock, AR (US)

(21) Appl. No.: 15/035,881

(22) PCT Filed: Oct. 10, 2014
(86) PCT No.: PCT/US14/60063

§ 371 Date: May 11, 2016

Related U.S. Application Data
(60) Provisional application No. 61/903,594, filed on Nov. 13, 2013.

(51) Int. Cl. B01D 29/21; B01D 46/52

(52) U.S. Cl. CPC B01D 29/21; B01D 46/521; B01D 2201/0415; B01D 2201/12; B01D 2201/291

(57) ABSTRACT

A cartridge filter includes a central core member having an axial dimension including a peripheral surface with a hollow interior, and a pervious filter material disposed about the peripheral surface of the core member. The filter material has a length substantially equal to the axial dimension of the core member and the core is an extruded non-woven tubular member having spaced-apart strand segments providing porous segments thereof. Axial ends of the core include solid band regions providing circumferentially continuous axial ends thereof, to thereby eliminate discrete, irregular edges that otherwise would be created by circumferentially spaced apart strand segments at each axial end of the core if the solid band regions were omitted.

### CROSS-REFERENCE TO RELATED APPLICATIONS

This international application claims the benefit under 35 U.S.C. §119(e) of U.S. Patent Application Ser. No. 61/903,594, filed Nov. 13, 2013, entitled CARTRIDGE FILTER, the disclosure of which is incorporated by reference herein.

### BACKGROUND

1. Field of the Invention

This invention related generally to filters, and more specifically to a cartridge filter including a central porous core and a filter member disposed about the periphery of the core.

2. Background Art

It is well known to form cartridge filters with extruded, porous cores and a filter material disposed about the core.

In prior art constructions, the tubular cores are formed by extruding a tubular plastic core in a well-known manner, to provide a periphery with spaced apart, non-woven strand segments that define the pores of the structure. The continuous extruded core is then severed into spaced apart axial components having an axial length substantially equal to the desired length of the filter core.

However, in prior art structure, after the extruded core is severed the axial ends of the core are provided by relatively rough and sharp edges of circumferentially spaced apart strand segments that define the pores of the core. These sharp edges can injure an individual handling the filter, and most significantly can damage a filter member as it is being assembled with the core. A prior art core having circumferentially spaced apart strand segments presenting sharp edges is shown in FIG. 1.

Extrusion equipment for extruding a non-woven plastic mesh core structure is well known in the art. For example, such equipment is sold by Corelco SAS, located at Manziat France, as well as at other locations in Europe. Extrusion equipment sold by Corelco has been utilized in the past to make the central, tubular, porous cores of prior art cartridge filters.

U.S. Pat. No. 3,917,889, discloses a variety of tubular net products and their methods of formation, including tubular products having spaced-apart strand segments defining passages in the structure and circumferentially continuous band regions. Typical structures are exemplified in FIGS. 8-14 of the '889 patent. Interesting, the '889 does not disclose any specific uses for the non-woven netting disclosed therein, and clearly does not teach or suggest use of the non-woven core material as a porous core of any filter structure. Moreover, even if the non-woven core disclosed in the '889 patent were to be employed as a filter core in a filter structure, such as a cartridge filter, there is no teaching or suggestion as to how the core would be so employed.

The subject matter of U.S. Pat. No. 3,917,889, is incorporated herein by reference, it being understood that he prior art does disclose the manner of operating extrusion equipment to form tubular, nonwoven net structures with circumferentially continuous band regions formed therein.

A need exists for a cartridge filter structure employing a porous non-woven core having circumferential ends that are continuous and smooth, to thereby avoid damaging the filter material as it is being assembled with the core, and also avoid harming individuals required to handle the core during formation of the filter structure. It is to such an arrangement the present invention relates.

### SUMMARY OF THE INVENTION

A cartridge filter in accordance with this invention includes a central core having an axial dimension and including a porous peripheral surface with a hollow interior. A filter material pervious to a fluid to be filtered, e.g., oil, gasoline, air, water, etc. is disposed about the peripheral surface of the core with the filter material having a length substantially equal to the axial dimension of the core. The core is an extruded non-woven tubular member having spaced- apart strand segments providing pores through the peripheral surface of said core. Axial end sections of the core include solid band regions providing circumferentially continuous axial ends free of sharp and rough edges.

Most preferably the core of the cartridge film is an extruded plastic material, most preferably a plastic material from the group consisting of polypropylene, polyethylene, polyamide, and polyester.

The pervious filter material employed in this invention can be any of a wide variety of well-known and even new filter constructions. In one preferred form of the invention the pervious filter material is a pleated construction disposed about the peripheral surface of the core.

In addition to including circumferential continuous band regions at the opposed axial ends of the extruded core, it is within the scope of this invention to provide one or more additional circumferentially continuous band regions spaced axially along the core between axial ends of the core, thereby still providing or creating one or more porous segments that are surrounded by filter material.

### BRIEF DESCRIPTION OF THE DRAWINGS

FIG. 1 is a fragmentary isometric view of a prior art filter core member showing the arrangement of circumferentially spaced apart strand segments that can form discrete, irregular edges at the ends of the core member;

FIG. 2 is an isometric view of a cartridge filter in accordance with this invention;

FIG. 3 is a sectional view taken along line 3-3 of FIG. 2;

FIG. 4 is a partially exploded isometric view of the cartridge filter shown in FIG. 2, showing details of construction of the porous core and related components; and

FIG. 5 is a sectional view taken along line 5-5 of FIG. 4.

### DESCRIPTION OF THE PREFERRED EMBODIMENTS OF THE INVENTION

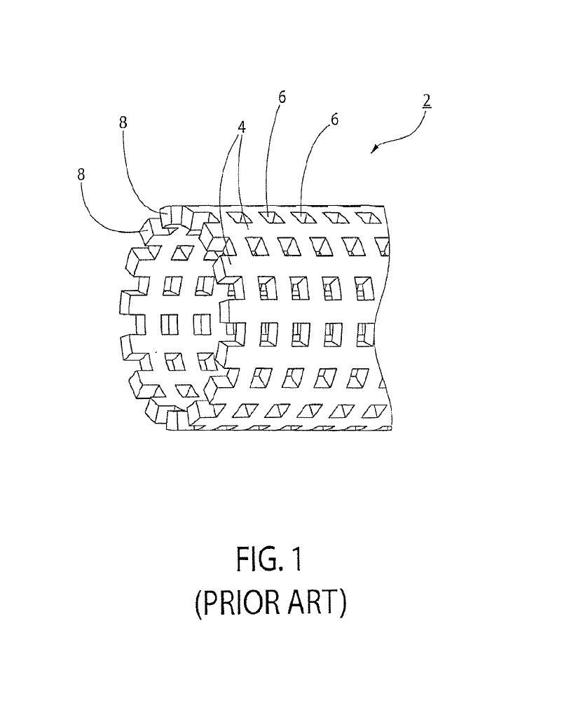

Referring to FIG. 1 a fragmentary isometric view of a prior art filter core is illustrated at 2. As is apparent this filter core is a porous, non-woven, extruded member having strand segments 4 defining pores 6 in the structure and also being circumferentially spaced-apart the ends thereof to provide discrete, irregular, exposed end edges 8.

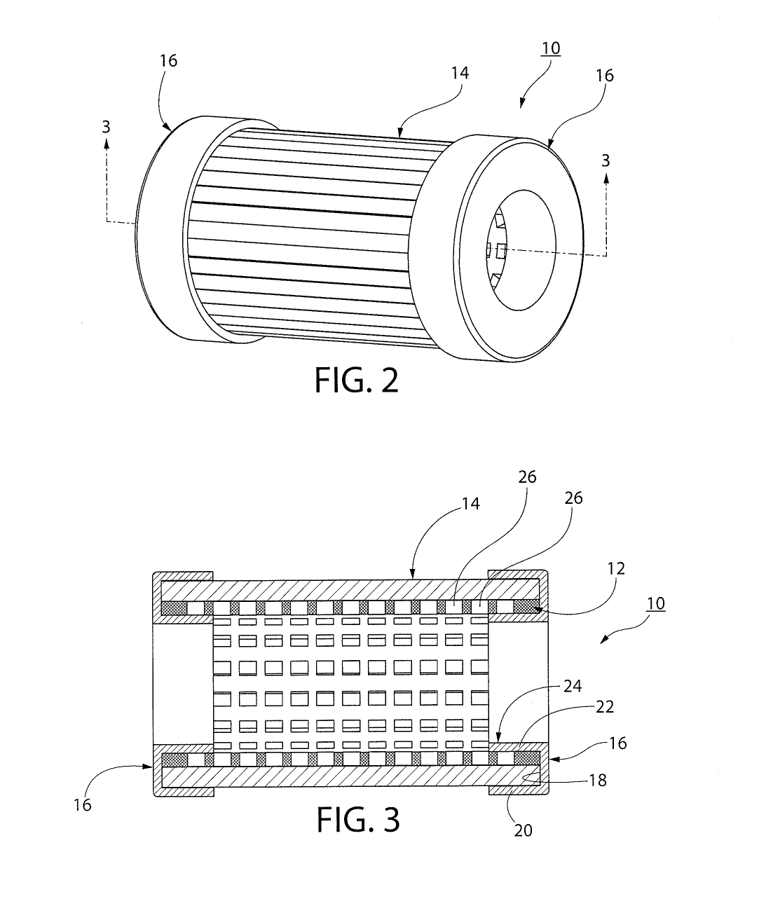

Referring to FIGS. 2 and 3, a cartridge filter in accordance with this invention is shown at 10. This filter 10 includes a central plastic core member 12 having a pervious filter material 14 disposed about the periphery thereof and a pair of end caps 16 closing the ends of the filter and being retained as part of the filter 10 by glue or other adhesive means (not shown) as is well known in the art.

Referring to FIG. 3, each of the end caps 16 includes a peripheral channel 18 provided by an outer circumferential wall 20 of the cap and a circumferential wall 22 of an internal flange member 24. As can be seen best in this FIG. 3, in the assembled condition of the cartridge filter 10 end sections of the pervious filter material 14 and the core member 12 seat within the circumferential channel 18 and glue inserted into the channel 18 fastens the end caps 16 to the core member and filter material. In the preferred embodiment glue disposed on the outer surface of circumferential wall 22 of the internal flange member 24 can pass through pores 26 of the porous nonwoven core member 12 to adhere to the overlying filter material 14; thereby enhancing the strength of the attachment of the caps 16 to the other structural components of the cartridge filter 10.

Although FIG. 3 shows a preferred embodiment of a cartridge filter employing end caps it should be understood that cartridge filters employing the features of this invention can be of a variety of constructions, including constructions that do not include end caps.

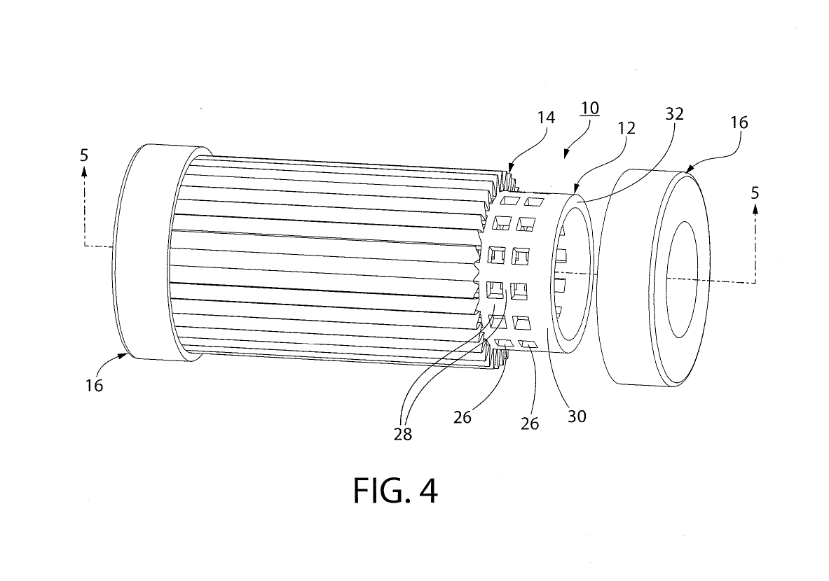

A partially exploded view of the cartridge filter 10 is illustrated in FIG. 4, and shows details of construction of the extruded nonwoven central core member 12 and the pleated filter material 14 disposed about the core member 12. The extruded core member 12 includes a plurality of spaced apart strand segments 28 providing the pores 26 extending through the periphery thereof. However, the axial end regions of the core member 12 include solid, circumferentially continuous band region 30 that provide smooth, circumferentially continuous outer edges 32 at each axial end of the core member. This is a very important feature of the present invention. If desired, additional, continuous band regions can be provided in the core member 12 axially spaced apart from each other and from the end band regions 30 to provide required porous regions 26 in the core member so as not to interfere with the desired filtering function

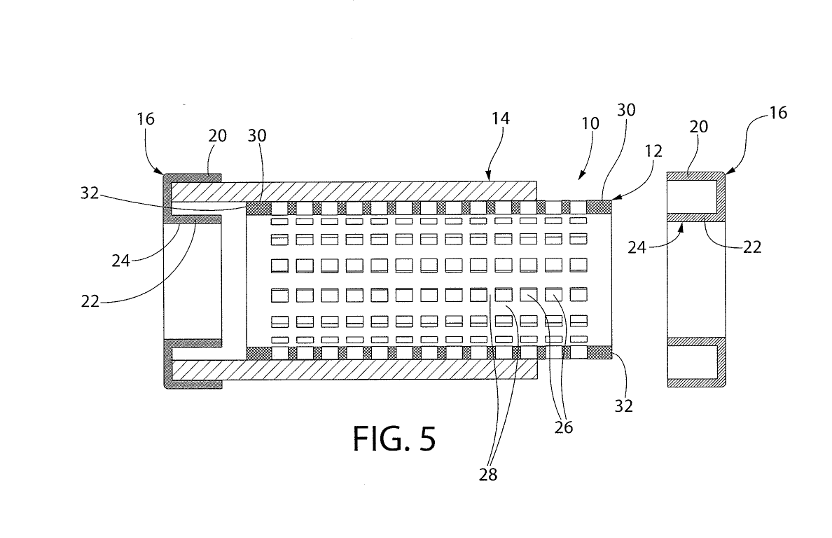

The central core member 12 has an axial dimension defined between the opposed outer end edges 32 of the band regions at the axial ends thereof, and the fluid pervious filter material 14 is disposed about the peripheral surface of the core member 12 overlying porous regions 26 thereof, as can be seen best in FIGS. 3 and 5.

In the most preferred embodiment, the pervious filter material 14 has a length substantially equal to the axial dimension of the core member 12, whereby the ends of the filter material and core member are substantially coterminous. However, although this is the most preferred relationship between the dimensions of the filter material 14 and the core member 12 there clearly is some room for the length of the filter material 14 to differ from the axial dimension of the core member 12; provided that in the cartridge filter 10 the end caps 16 can be employed to effectively seal the ends of the filter 10 and to aid in securing the components thereof together.

As noted earlier, the core member 12 is an extruded non-woven tubular member having spaced-apart strand segments 28 providing pores 26 there between.

However, in accordance with a unique feature of this invention axial ends of the core member 12 have circumferentially continuous solid band regions 30 that provide the circumferentially continuous axially spaced-apart end edges 32 to thereby eliminate discrete, irregular end edges 8 that otherwise would be created by the circumferentially spaced-apart strand segments 4 (FIG. 1) if the band regions 30 were not provided in the structure.

It should be understood that in accordance with the broadest aspects of the invention the filter material 14 need not be pleated and can be of any desired construction, provided it is pervious to the fluid to be filtered. Moreover, the cartridge filter 10 of this invention is not limited to the filtering of any specific fluid and may be used for filtering a wide variety of fluids, e.g., air, water, oil, gasoline, etc.

This specific material(s) employed as the filtering media 14 does not constitute a limitation on the broadest aspects of this invention. The filter material can be a single layer or multi-layer structure including a wide variety of materials. For example, and not by way of limitation, a multi-layer structure can include one or more melt blown layers, one or more spun bond layers and/or one or more carded layers. If desired the pervious filter media can be provided with an outer, extruded, non-woven facing sheet, as is known in the art.

In accordance with this invention, reference to the length of the filter material 14 being substantially equal to the axial dimension of the core member 12 means that there is not a significant disparity between their respective lengths. Clearly the axial length of the core member 12 cannot be substantially less than the length of the filter material 14; otherwise the filter material 14 would not be adequately supported to provide its required filtering function.

Although the axial length of the core member 12 can be greater than the length of the filter material 14 there is essentially no good reason to provide such an arrangement, since the core member 12 would simply take up additional space without providing any useful function. Also, if the axial dimension of the core member 12 is greater than the axial dimension of the filter material 14 then the portion of the core extending beyond the end of the filter material would need to be solid or otherwise covered to prevent fluid to be filtered from passing through core member 12 without being filtered by passing through the filter material 14.

Although this invention has been described with a certain degree of particularity, it is to be understood that the present disclosure has been made by way of example only and that numerous changes in the details of construction and the combination and arrangement of elements may be resorted to without departing from the spirit and the scope of the invention as herein after claimed.

We claim:

1. A cartridge filter including a central core having an axial dimension and including a porous peripheral surface with a hollow interior, a fluid pervious filter material disposed about the peripheral surface of the core overlying the porous surface, said filter material having a length substantially equal to the axial dimension of the core, said core being an extruded non-woven tubular member having spaced apart strand segments providing pores through said peripheral surface, axial ends of said core including solid band regions providing circumferentially continuous, axial ends, thereby eliminating discrete, irregular edges that otherwise would be created by circumferentially spaced-apart ends of the strand segments.

2. The cartridge filter of claim 1, wherein the core is an extruded plastic material.

3. The cartridge filter of claim 1, wherein the pervious filter material is a pleated filter member.

4. The cartridge filter of claim 1, including one or more continuous circumferential band regions intermediate the solid band regions at the axial ends of the core.

5. The cartridge filter of claim 1, wherein the core is extruded of a plastic material from the group consisting of polypropylene, polyethylene, polyamide and polyester.
